(19) United States
(12) Patent Application Publication
(10) Pub. No.: US 2002/0092215 A1
(43) Pub. Date: Jul. 18, 2002

(54) Foldable sheet member including a graphic image and being apt to be arranged in a self-supporting erect position process for its manufacture, and toy shooting device

(76) Inventors: Francisco Lopez Fernandez, (US); Fernando Mestres Armengol, (US)

Correspondence Address: JACOBSON HOLMAN, PROFESSIONAL LIMITED LIABILITY COMPANY, 400 SEVENTH STREET, N.W., WASHINGTON, DC, 20004, US

(21) Appl. No.: 09/983,823

(22) Filed: Oct. 26, 2001

Related U.S. Application Data
(63) Continuation of application No. PCT/ES00/00153, filed on Apr. 26, 2000.

(30) Foreign Application Priority Data
Apr. 27, 1999 (ES) U 9901186

(51) Int. Cl. G09F 1/00; A47G 1/06

(52) U.S. Cl. 40/124.09; 40/765

(57) ABSTRACT

A foldable sheet member including a graphic image and being apt to be arranged in a self-supporting erect position The sheet member comprises front and back sheets (3, 4) superimposed one another and bonded together, said back sheet (4) integrating a flap (8) connected through a folding line (6) allowing said flap (8) to turn. A slit (7) adjoining folding line (6) defines a tongue (9). Front and back sheets (3, 4) are bonded together by means of at least one adhesive dot (11) or a stripe (21) being parallel to folding line (6) at a selected distance therefrom. Said flap (8) can adopt two stable positions; a first stable position in which flap (8) is coplanar with the rest of said back sheet (4) and superimposed on the front sheet (3), and a second stable position in which said flap (8) adopts an inclined position. The folding line (6) is directly opposed to respective edges of flap (8) and front sheet (3) intended to rest on a supporting surface when the foldable sheet member is supported in said erected position by said flap (8) when in said second stable position. Said tongue (9) leaning against the back of front sheet (3) provides an elastic force that opposes the folding of flap (8) to said first stable position.

### TECHNICAL FIELD

The present invention relates to a foldable sheet member including a graphic image of various kinds such as a drawing, a picture card, a photographic reproduction, a visiting card, etc. and being apt to be arranged in a self-supporting erect position, in particular slightly backwardly inclined position, and resting either on a broad side or on a narrow side. Said support is of the type made from at least one piece of sheet material on which a graphic image has been printed or which supports a planar member with a graphic image printed on

The present invention does also relate to a process for the manufacture of the sheet support and to a toy shooting device formed as per alternative embodiments of said sheet support

The present invention is of use in the graphic arts sector, and is apt to be put to various uses. One of such uses is the manufacture of picture cards integrating a prop or stand and reproducing for example figures or personages, and allowing to organize different games. Another use for the present invention is as a frame to hold photographs or postcards or as an advertising display. Still another use as per a particular exemplary embodiment of the present invention is that exemplified by a sheet article reproducing a motif with its contour die-cut, at least in part, and provided with a foldable stand, said article being apt to be folded in a salient-free arrangement facilitating, e.g., its insertion into envelopes by means of conventional, automated machines. An exemplary embodiment of the process of the invention allows to manufacture visiting cards or personalized cards possibly made in very short runs and at a very low cost.

### BACKGROUND OF THE INVENTION

As background of the invention can be cited the Utility Model ES-A-1035348 concerning an improved picture card including a die-cut silhouette of sheet material laterally extending into toes provided with slits and once properly erected forming a stand.

As compared with said background the prop means of this invention are totally different thus providing a higher toughness and not requiring the execution of a complex erecting or dismounting task. The planar arrangement of the assembly cited in connection with said prior utility model does on the other hand entail the risk that some of the die-cut portions remain in the erect position, this not happening with the approach being set forth here. As will be besides apparent the structure of the sheet support proposed allows to generally put it to many other uses for graphic images of various kinds, which cannot be done by means of the commented background device.

Other known background documents that can be cited are the Utility Model ES-A-1039980 relating to an articulated picture card, the Utility Model ES-A-1039564 concerning a display support forming a stand and also made from a sheet support, and the Patent ES-A-2072182 disclosing a self-supporting support for pictures or illustrated cards.

Patent GB-A-742214 discloses a foldable support to maintain a graphic motif in a substantially upright position on an horizontal surface. The support comprises a single piece of cardboard or like material including an attachment portion, adapted to be secured flat against the back of the showcard or other article to be supported, and one or more wings including one or more projections extending, when the attachment portion and the wing are co-planar, beyond a straight scored line defining the junction between the attachment portion and the wing so that, when the supporting device is attached to a showcard or other article and the wing is bent outwardly through more than a right angle, edges of the projections will engage the back of the said article and oppose the return of the wing to its flat position.

Said antecedent does not, however, disclose or suggest said straight scored line being directly opposed to that edge of the front sheet (e.g. a showcard) intended to rest on the supporting surface. Therefore, the edge of the wing that is intended to rest on the supporting surface is the one adjacent to the straight scored line. It means that the wing acts as a conventional square bracket and said one or more projections serve only to avoid folding of the wing, with no role in maintaining the front sheet upright. There is neither disclosure or suggestion that the one or more projections are intended to exert an elastic force cooperating to maintain upright the support and the front sheet.

Patent GB-A-742214 includes all the features of the preamble of main claim 1.

### SUMMARY OF THE INVENTION

Unlike all of these background documents the present invention is characterized in that it comprises at least a front sheet provided with a graphic image or supporting a planar member with a graphic image printed on it, and a back sheet being superimposed on and bonded to said front sheet. From said back sheet derives at least one flap connected to it through one or more portions integrating a folding line being transverse to the sheet and allowing to turn said flap. At least one edge of the flap is defined by a slit adjoining said folding line and determining a toe or tongue, in such a way that when said flap is turned and said toe is facing the front sheet said toe or tongue causes elastic forces that reach their maximum when the flap and the front sheet are perpendicular to each other, by virtue of said elastic forces said flap tending to adopt two only stable, differentiated positions. In a first one of said stable positions the flap is coplanar with the back sheet and superimposed on the front sheet, whereas in a second one of said stable positions the movable portion of the back sheet is arranged in an inclined arrangement thus propping the assembly consisting of the front and back sheets, said prop being apt to maintain said assembly in an erect position on a flat surface.

This is due to the fact that when said flap is manually turned its corresponding toe(s) or tongue(s) exert an increasing pressure against the front sheet, said pressure producing elastic deformation forces that become increasingly bigger as the flap approaches a position in which it is perpendicular to the back sheet. Said perpendicular position of the flap with respect to the front sheet is hence a position of maximum instability causing said flap to be biased thus tending to turn in one or the other sense. A restoring force of the folding line of the flap is nevertheless also present, said force being all the bigger as the folding angle of the flap is increased or respectively decreased with respect to the back sheet. When the flap is thus being turned in a sector in which the folding line is the vertex of a folding angle with respect to the back sheet of more than 90° said elastic deformation forces are added up to said restoring force thus biasing the flap into adopting said first position in which said flap is coplanar with the back sheet and superimposed on the back sheet. On the contrary, when the flap is being turned in a sector in which the folding line is the vertex of a folding angle with respect to the back sheet of less than 90° the elastic deformation forces are counteracted by the restoring force, this resulting in a balanced condition wherein the flap adopts said second inclined position with respect to the front sheet.

When in said coplanar position with respect to the back sheet, said flap determines a planar assembly with no salient portions, said arrangement being specially favorable for the automatic insertion of said sheet assembly into envelopes by means of a standard machine thus sensibly reducing the cost for the manipulation of the assembly even if the graphic image includes cut out portions that will always be covered by said flap in its folded position thus generally determining a rectangular assembly.

In a first exemplary embodiment said back and front sheets are formed from one only sheet element with two portions being superimposed from a folding line and bonded together by means of one or more adhesive spots or stripes.

In another exemplary embodiment said front and back sheets are independent and are attached to each other by means of one or more adhesive spots or stripes or by means of slits by way of clip, said front sheet consisting in said planar member with a graphic image printed on it.

The process of the present invention is apt to be used to manufacture the sheet support of the present invention in one of its exemplary embodiments. The essential object of the process is to produce unprinted, semiprocessed sheet subassemblies apt to be printed by means of medium or small size printing units, and to ulteriorly be cut into individual sheet support elements each provided with its own printed, graphic image. The benefit afforded by the process of the invention lies in that it allows to make for example personalized cards provided with erect position upholding means in very short runs at a price only slightly higher than that of conventional cards, Subassemblies of the mentioned type can be for example commercialized in a standardized size usually produced by small printing plants and office or domestic printers, each subassembly being prepared for eight or ten cards with stand, said cards being possibly printed with an identical graphic information in reduced runs such as of a few hundred or less, or possibly being printed each with a different graphic information personalized from a graphic information created, e.g., by means of a text processing program in a personal computer. The subassemblies are in both cases apt to be once printed cut by means of a small guillotine, a cutter or a pair of scissors. Besides fulfilling their classic function, these personalized cards with stand can be used, e.g., to display the names of the participants at a meeting or discussion, to indicate the places to be taken by the people gathering at a banquet, to display the prices of the articles in a window, and in similar instances.

According to the present invention a toy shooting device is also provided which is formed from a sheet support as per a particular embodiment of the present invention for whose design the chosen dimensions, ratios and materials make the assembly strong and resilient enough to be apt to be used as a toy shooting device by slightly pressing or tapping its top to thus simulate, for example, a ball game.

### BRIEF DESCRIPTION OF THE DRAWINGS

These and other characteristics of the sheet support of the present invention will be best made apparent by the following description of some preferred exemplary embodiments referring to the enclosed drawings wherein:

FIGS. 1 through 1d illustrate a plan and several perspective views showing several steps in the formation and use of an exemplary embodiment of the sheet support of the present invention made from one only base sheet, the forces exerted by the toes or tongues against the front sheet being indicated with small arrows in FIG. 1c and being the reason for their above-mentioned bistable condition;

FIGS. 2, 2a, 3, 3a and 4, 4a do respectively show in a partial plan-view and in a perspective view the connection of said flap provided to serve as an upholder or prop to the back sheet of the support, the different pairs of figures showing different possible configurations of the turnable edge of said flap;

FIGS. 5, 5a and 5b show an alternative embodiment where the contour of the graphic image has been partially cut out;

FIGS. 6 and 7 show different exemplary embodiments where the front sheet and the back sheet forming the proposed sheet support are made in an independent manner and are ulteriorly bonded together to thus form the support assembly;

FIGS. 8, 8a and 8b show another exemplary embodiment of the invention where the front sheet upon which said flap acts derives from a panel provided with an opening in the shape of a frame upon erection of the assembly defining an inlet for a planar member provided with a graphic image that will be displayed through said frame;

FIGS. 9 and 9a illustrate in a plan and a perspective view a toy shooting device obtained from a particular alternative embodiment of the sheet support of the invention;

FIG. 9b shows in a perspective view a complement to the toy shooting device of FIGS. 9 and 9a;

FIGS. 10 through 10d illustrate in plan and perspective views another exemplary embodiment of the invention where both the front and rear sheets are round-shaped and where the edges of front sheet and flap resting on the supporting surface are curved;

FIGS. 11 and 11a are perspective views showing the foldable sheet member of FIGS. 10 through 10d whit an aperture in said flap enabling said sheet member to be fastened to a button;

FIGS. 12 through 12b are perspective views showing the foldable sheet member of FIGS. 10 through 10d whit a slit configuration in said flap enabling said sheet member to be fastened to the edge of a page; and

FIGS. 13 through 13c illustrate the manufacturing process for the manufacture of the sheet support as per a particular exemplary embodiment of the invention.

### DETAILED DESCRIPTION OF PREFERRED EXEMPLARY EMBODIMENTS

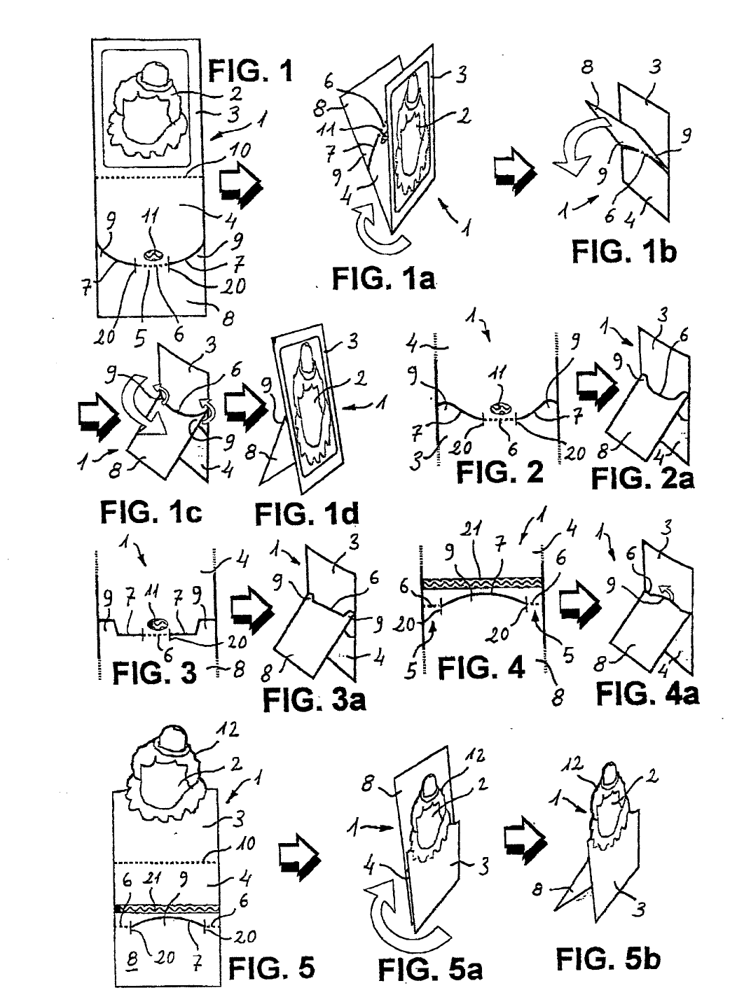

Reference is firstly made in general to the foldable sheet support as per the present invention which in any of its possible alternative embodiments (shown in FIGS. 1 through 8b) does always comprise a front sheet 3 generally bearing a graphic image 2, and a back sheet 4, said sheets being mutually superimposed and attached. From said back sheet 4 derives a flap 8 connected through at least a portion 5 to the rest of said back sheet 4, said portion or portions 5 including a folding line 6 (advantageously provided with an indentation) being transverse to sheet 4 and allowing to turn said flap 8, at least one edge of flap 8 being defined by one or more slits 7 adjoining said folding line 6 and determining one or more toes or tongues 9. At the junctions between said slit or slits 7 and the folding line or lines 6 small transverse slits 20 have been cut to prevent said folding line 6 from being torn and also and depending on their length to influence the flexibility of said at least one toe or tongue 9.

Such an arrangement determines that when turning said flap 8 thus causing said toe or toes 9 to face front sheet 3 elastic deformation forces are created which reach a maximum when the flap is in a perpendicular position with respect to the front panel. By virtue of said elastic deformation forces and of other forces due to the restoring tendency caused by folding line 6 flap 8 tends to adopt two only differentiated, stable positions. In a first stable position flap 8 is coplanar with the rest of said back sheet 4 and superimposed on front sheet 3, whereas in a second stable position flap 8 adopts an inclined position with respect to front sheet 3 thus forming a prop holding up the assembly in an erect position on a flat surface.

FIGS. 1-1d show an exemplary embodiment wherein said back sheet 4 and front sheet 3 are formed from one only sheet element 1 with two portions being mutually superimposed from a folding line 10 and firmly bonded together by means of at least one adhesive spot or area 11. Portion 5 connecting flap 8 to back sheet 4 and including folding line 6 is located in a central area, whereas two toes 9 are each delimited by a respective curved slit 7 having been provided at the respective side of folding line 6, said slits 7 and said folding line 6 being separated by said small transverse slits 20. Toes or tongues 9 thus have tips projecting from flap 8 and pressing front sheet 3 at its lateral sides when said flap is in said second position (FIG. 1c).

FIGS. 2, 2a and 3, 3a show other alternative embodiments with toes 9 of flap 8 situated at the lateral ends of the central folding line 6. Slits 7 of the exemplary embodiment of FIGS. 2 and 2a have been shaped as a double curve, toes 9 for this reason having rounded tips, whereas slits 7 of the exemplary embodiment of FIGS. 3 and 3a have straight lengths, toes or tongues 9 therefore having flat tips to press front sheet 3.

Another exemplary embodiment of toe 9 is shown in FIGS. 4 and 4a, In this example the connecting lengths provided between back sheet 4 and flap 8 and including folding line 6 are situated at the lateral ends in such a way that one only slit 7 defines a toe or tongue 9 spanning an ample central area. The back sheet is bonded to the front sheet by means of an adhesive stripe 21 extending through the whole width of the sheet support. The distance between said adhesive stripe 21 and the folding line is of great import since it has a substantial influence on the elastic deformation force produced by the pressure of tongue 9 against front sheet 3, said force becoming all the bigger as said distance is reduced.

The exemplary embodiment of FIGS. 5 through 5b is similar to that of FIGS. 1 through 1d, with a tongue design similar to that of FIG. 4, but now front sheet 3 has been cut out following at least in part a contour 12 of the graphic image 2. In said first position coplanar with back sheet 4 (FIG. 5a) flap 8 does nevertheless fully cover said cut out contour 12, in such a way that the assembly is arranged as per a sheet-like arrangement with straight and regular edges thus being apt to be easily introduced into an envelope either by hand or by means of a machine.

In this way, both if the graphic image is flat as well as if it has had a portion of its contour cut out the described front and back sheet assembly is specially apt to be introduced into envelopes by means of standard automated machines.

It must be noted that although the sheet supports shown in FIGS. 1 through 5b have been described as having been obtained from one only sheet element 1 the front sheet 3 and the back sheet 4 with flap 8 can also be independent sheet pieces attached to each other by means of an adhesive or through mechanical means with the same result.

FIG. 6 shows an exemplary embodiment of the sheet support of the present invention wherein said front sheet 3 and back sheet 4 are independent and are ulteriorly bonded together at a point in time in the manufacturing process or by the user him- or herself by means of an adhesive 13 which in the illustrated example is an adhesive layer 13 extending through an ample area of the back sheet 4 and being initially protected with a releasable paper 22 provided to be removed by the user to thus bond back sheet 4 to front sheet 3 formed by a planar member with a graphic image 2 printed on it such as in the case of a picture card, a written card or the like.

In the example of FIG. 7 the back sheet 4 has slits 14 defining clip means. Front sheet 3 is attached to said back sheet 4 by means of introducing at least two, and preferably three, of its peripheral sides into said slits 14 thus forming a detachable attachment. In the illustrated example a portion of the back sheet 4 is wider than the front sheet 3, and flap 8 is as wide as or less wide than front sheet 3.

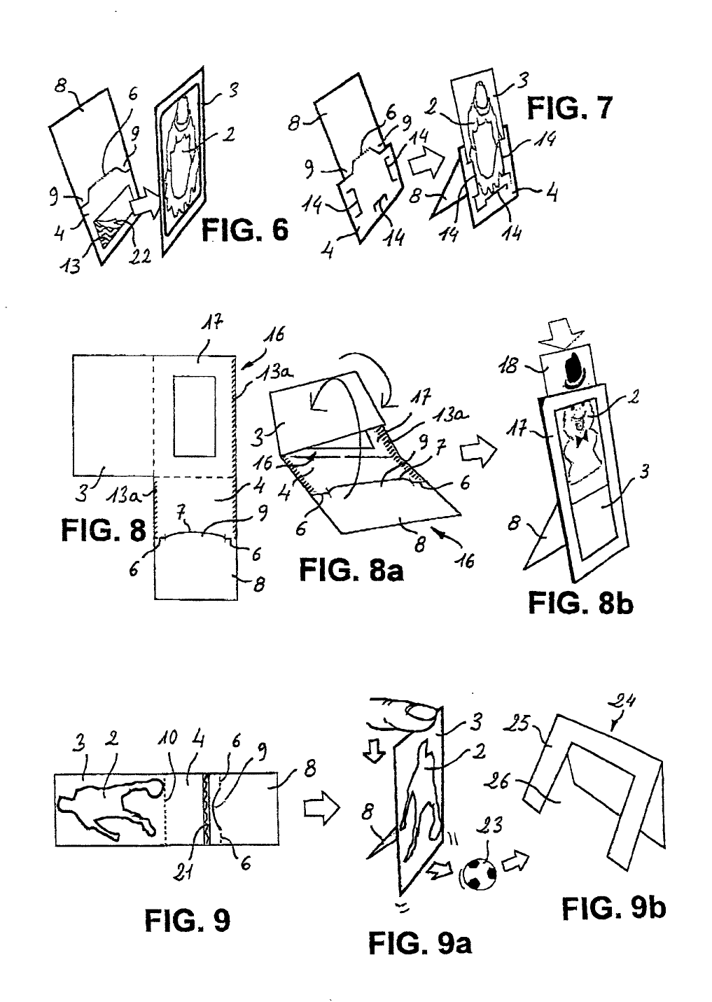

FIGS. 8 through 8b show an exemplary embodiment of the invention wherein said graphic image 2 is printed on a planar member 18, this latter being independent and removably supported by said front sheet 3. Said front sheet 3 for such a purpose integrates a superimposed panel 16 with a cutaway central area by way of a frame 17, said panel 16 deriving from a lateral side of front sheet 3 and being bonded by means of an adhesive to the opposite lateral side of said front sheet thus defining at least one inlet passage between front sheet 3 and said panel 16 for the introduction of said planar member 18 with a graphic image 2 printed on it, said graphic image 2 being visible through said frame 17. The figures illustrate adhesive stripes 13 provided on a lateral side of panel 16 and on the lateral edges of back sheet 4 thus facilitating the assembly of the sheet support.

The contour of one or more flaps 8 can be die-cut in back sheet 4 in such a way that said flap 8 is surrounded by a sort of frame formed by the rest of back sheet 4, this latter thus not having its contour altered when flap 8 is arranged in the above-mentioned first position (not shown).

FIGS. 9 through 9b show a toy shooting device formed by a sheet support as per a particular exemplary embodiment of the present invention carried out in accordance with the basic principle described in connection with FIGS. 1 through 5b but wherein the selected dimensional ratios and materials are such that when resting in an erect position on a flat surface and with flap 8 in said second position said sheet support admits certain repeated strains produced by pressing or tapping the topmost edge of front sheet 3 without folding and in such a way that said strains cause the bottom end of said front sheet 3 to be flipped forwards thus being in a position to impel a small object such as a small paper ball or a small ball 23 placed in front of the sheet support on said flat surface. One or more users can for example organize a game by arranging several of said toy shooting devices with their corresponding graphic images 2 printed on the front sheets 3 reproducing the images of players of a sport using a ball or the like, such as in football or hockey, and by impelling a small ball 23 or a small paper ball with the front sheets 3 by means of tapping or slightly pressing with the finger the top of said front sheet (FIG. 9a), in order to thus try to introduce the small ball 23 into a goal. The present invention does besides provide as a complement to the toy shooting device a goal 24 such as a football or hockey goal formed by a sheet bent along a transverse folding line thus defining two planes arranged in the shape of an inverted “V” having one of its slopes 25 cut out thus defining an opening 26 by way of the entry into said goal 24.

Said dimensional ratios (FIG. 9) are at least a length of flap 8 of about 45% to 55%, preferably 50%, of the length of front sheet 3; a location of folding line 6 at about 45% to 55%, preferably 50%, of the length of front sheet 3 from a bottom edge of this latter; a distance from adhesive stripe 21 to folding line 6 of about 5% to 20% of the length of flap 8, and a length of toe or tongue 9 of about 5% to 10% of the length of flap 8. The sheet material is a cardboard or paperboard having at least one of its sides coated with plastic.

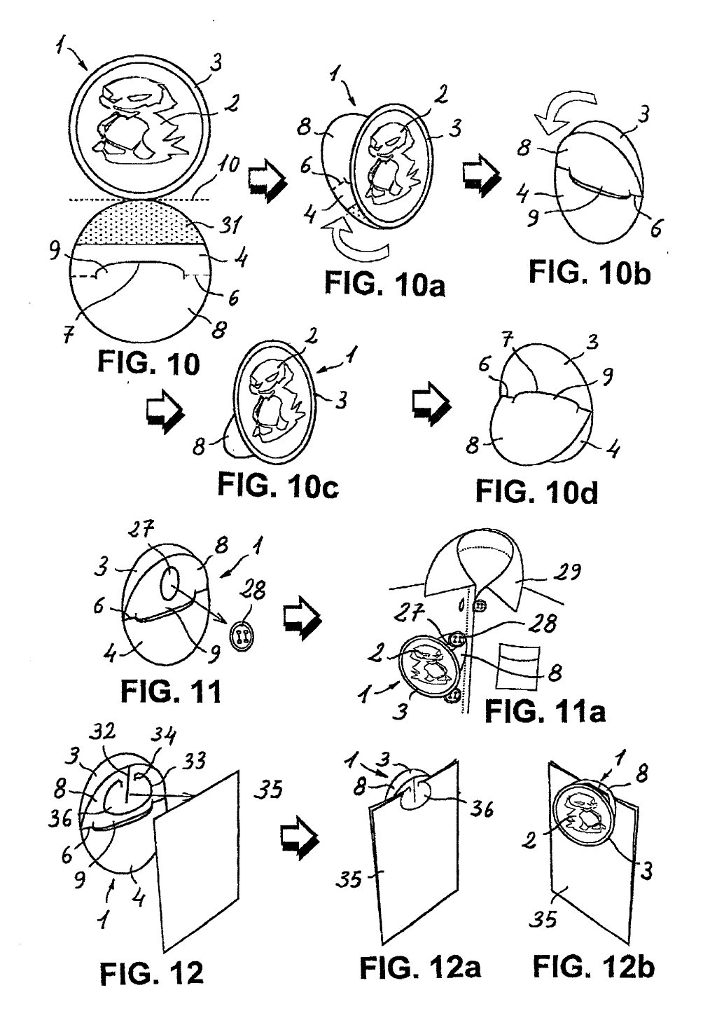

Attention is turned now to FIGS. 10 through 10d. The foldable sheet member shown in a planar condition in FIG. 10 includes all the basic features of the previous embodiments, for example that shown in FIG. 5, but here both the front and rear sheets 3, 4 are round-shaped. On the front side of front sheet 3 a graphic image 2 is provided. The foldable sheet member is preferably formed from one only sheet element 1 with two round portions constituting front and rear sheets 3, 4 being mutually superimposed from a folding line 10 of short length and bonded together by means of an adhesive region 31 at a selected distance from a folding line 6 thus allowing to turn flap 8 about said folding line 6. One slit 7 adjoining said folding line 6 defines a tongue 9.

FIGS. 10a through 10d shows the way of setting up and using the foldable sheet element in FIG. 10 that are substantially the same as in previous embodiments. Note however that in this case the edges of front sheet 3 and flap 8 resting on the supporting surface are curved and also directly opposed to folding line 6.

By “round-shaped” configuration is meant to include front and rear sheets 3, 4 with a completely circular shape or with elliptic, ovoid or other irregular rounded shapes, optionally with the uppermost edge following at least in part a contour of the graphic image 2. Also, an adhesive stripe parallel to folding line 6 or one or more adhesive dots may be provided instead of the adhesive region 31 with the same result.

In FIGS. 11 and 11a a foldable sheet member as described with reference to FIGS. 10 through 10d is shown in which an aperture 27 in said flap 8 is provided, said aperture 27 being of a size enough to be passed over a button 28 of a usual garment size. Aperture 27 in flap 8 enables said sheet member when in a folded condition to be fastened to a button 28 of a garment 29, as shown in FIG. 11a.

FIGS. 12 through 12b show a foldable sheet member as per FIGS. 10 through 10d in which a slit configuration in said flap 8 is provided. Said slit configuration includes a straight slit 32 that runs from the edge of flap 8 intended to rest on the supporting surface to near the tongue 9 or folding line 6 and a rounded slit 33 that surrounds the inner end of said straight slit 32 and has inwardly bent ends 34 at both sides of straight slit 32 near said edge of flap 8. Said slit configuration 32, 33, 34 defines a second flap 36 inside flap 8, second flap 36 that enabling said sheet member when in a folded condition to be fastened to one edge of any piece of sheet material, such as one or more sheets of paper 35 as shown in FIGS. 11a and 11b, one or more pages of a book or the chest pocket of a shirt (not shown).

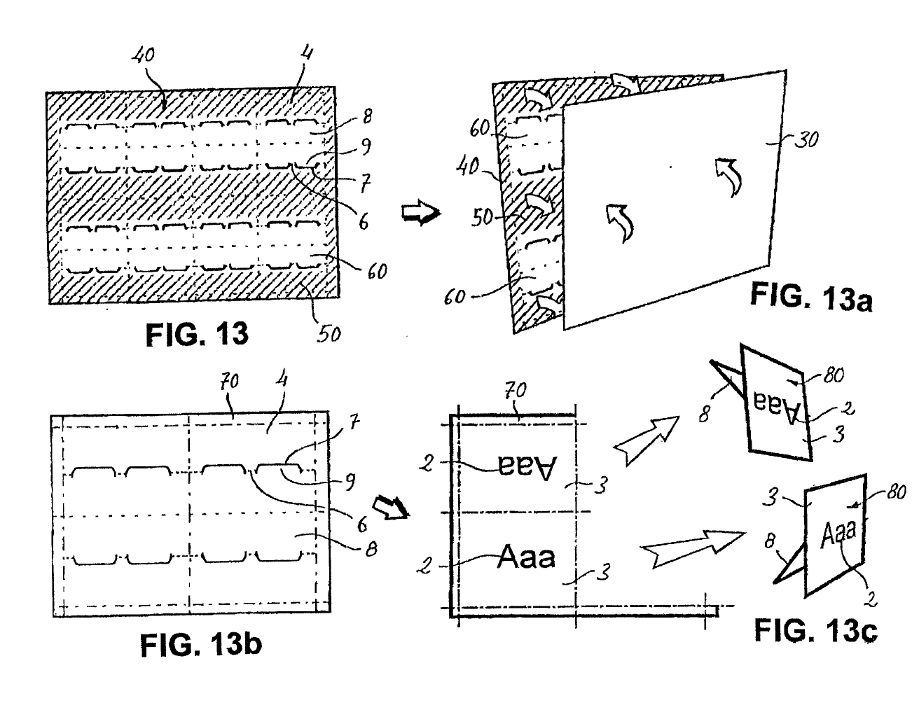

FIGS. 13 through 13c illustrate the process for manufacturing a sheet support as per a particular exemplary embodiment of the present invention. Such process includes the following steps:

FIG. 13 illustrates a step a) consisting in die-forming on a back sheet of advantageously big extension 40 a number of slits 7 and indentations at preestablished locations respectively corresponding to toes or tongues 9 and to folding lines 6 of a plurality of flaps 8 of corresponding adjacent back sheets 4 provided to be obtained from said back sheet of big extension 40. Step a) can also include preparing said back sheet of big extension 40 comprising printing on it at least guiding lines for said die-forming of said slits and indentations, and/or guides for an ulterior cutting into subassemblies, and/or guides for said final cutting into individual sheet support elements.

FIG. 13 does also illustrate a step b) consisting in applying an adhesive layer 50 (indicated by means of a crosshatching in FIG. 13) on said back sheet of big extension 40 leaving reserved inner areas 60 with no adhesive including at least regions corresponding to said flaps 8 with their toes or tongues 9.

FIG. 13a illustrates a step c) consisting in superimposing and bonding by means of said adhesive layer 50 said back sheet of big extension 40 on and to a front sheet of big extension 30 of the same dimensions thus forming an assembly consisting of said front and back sheets of big extension 30, 40 bonded together at least all around their contour.

A step d) is thereupon carried out and consists in cutting said assembly consisting of said front and back sheets of big extension 30, 40 bonded together, said cutting following said cutting lines marked on one or the other visible surface of said front and back sheets of big extension 30, 40, in order to thus obtain subassemblies 70 containing several of said sheet supports apt to be printed and cut into individual sheet support elements 80, or in order to thus directly obtain individual sheet support elements apt to be printed, not shown.

FIG. 13b shows one of such subassemblies 70 at an enlarged scale. The outer dimensions of subassembly 70 make it apt to be printed in medium or small size printing plants or in office or domestic printers. Said printing of the graphic images 2 is carried out on at least the front sheet of big extension 30 of said subassemblies containing several sheet supports, each of said equal or different graphic images 2 being arranged in a portion corresponding to one of said sheet supports before cutting said subassemblies into individual sheet support elements 80 as shown in FIG. 13c.

The graphic images 2 can nevertheless be also printed on at least the front sheet 3 of each of said sheet supports once having been cut into individual elements 80, or on at least the front sheet of big extension 30 of the assemblies formed by the front and back sheets of big extension 30, 40 bonded together and obtained from step c) before having cut said assemblies into individual sheet support elements, or even on at least the front sheet of big extension 30 before bonding it to the back sheet of big extension 40 in step c).

Although not shown, in an exemplary embodiment of the present support said front sheet 3 integrates in at least some areas an adhesive layer to removably bond said planar member 18 with a graphic image printed on it, said adhesive layer being protected by a removable sheet when not in use.

1. A foldable sheet member including a graphic image and being apt to be arranged in a self-supporting erect position, of the type formed from at least one piece of sheet material (1) supporting a graphic image (2), said at least one piece of sheet material (1) comprising a front sheet (3) and a back sheet (4) superimposed one another and bonded together, said back sheet (4) integrating at least one flap (8) connected through at least one portion (5) to the rest of said back sheet (4), said portion (5) incorporating a folding line (6) allowing to turn said flap (8) into a position propping the sheet member, one edge of flap (8) being defined by at least one slit (7) adjoining said folding line (6) and determining at least one toe or tongue (9), said flap (8) being apt to adopt two different, stable positions; a first stable position in which flap (8) is coplanar with the rest of said back sheet (4) and superimposed on the front sheet (3), and a second stable position in which said flap (8) adopts an inclined position, characterized in that:
said folding line (6) is directly opposed to one edge of the flap (8) and to one edge of front sheet (3) both intended to rest on a supporting surface when said flap (8) is in said second stable position, the foldable sheet member being supported in said erected position by an elastic force opposing the folding of the flap (8) to said first stable position;
said tongue (9) of said flap (8) when in said second stable position leans against the back of front sheet (3) thereby providing said elastic force opposing to the folding of the flap (8), and said two sheet elements (3, 4) are bonded together by means of at least one adhesive dot (11) or a stripe (21) being parallel to folding line (6) at a distance therefrom that determines said elastic force produced by the leaning of tongue (9) against front sheet (3), said force becoming all the bigger as said distance is reduced.

2. A foldable sheet member as per claim 1, characterized in that said back sheet (4) and front sheet (3) are formed from one only sheet element (1) with two portions mutually superimposed from a folding line (10) and bonded together by means of at least one adhesive spot (11) thus allowing to turn flap (8).

3. A foldable sheet member as per claim 1, characterized in that said front sheet (3) and said back sheet (4) are two independent sheet elements being mutually superimposed and bonded together and allowing to turn flap (8).

4. A foldable sheet member as per claim 1, characterized in that at the junctions between said at least one slit (7) and said at least one folding line (6) small transverse slits (20) are arranged to prevent said folding line (6) from being torn and to influence the flexibility of said at least one toe or tongue (9).

5. A foldable sheet member as per claim 1, characterized in that said graphic image (2) has been printed on said front sheet (3).

6. A foldable sheet member as per claim 5, characterized in that it does besides include other graphic images printed on those areas being visible when flap (8) is both in the first position and in the second position, namely on one portion of the internal surface of front sheet (3), on the external surface of back sheet (4), and on both surfaces of flap (8).

7. A foldable sheet member as per claim 1, characterized in that said front sheet (3) has been cut out following at least in part a contour (12) of the graphic image (2), whereas in said first coplanar position said flap (8) of the back sheet (4) completely covers said contour (12), in such a way that the assembly adopts a sheet-like arrangement with regular edges apt to be introduced into envelopes.

8. A foldable sheet member as per claim 1, characterized in that said front sheet (3) integrates a superimposed panel (16) with a cutaway central area provided by way of a frame, said panel (16) deriving from a lateral side of front sheet (3) and being attached to the opposite lateral side of this latter thus defining at least one inlet passage between front sheet (3) and said panel (16) for the introduction of said planar member (18) with a graphic image (2) printed thereon, said graphic image (2) being visible through said frame (17).

9. A foldable sheet member as per claim 1, characterized in that said front sheet (3) integrates at least in some areas an adhesive layer for the detachable attachment of said planar member (18) with a graphic image (2) printed on it, said adhesive layer being protected by a releasable sheet when not in use.

10. A foldable sheet member as per claim 3, characterized in that said back sheet (4) has slits (14) defining a clip means, and in that said front sheet (3) is detachably attached to said back sheet (4) by introducing at least some portions of two of its edges or corners into said slits (14), back sheet (4) being wider than front sheet (3), and said flap (8) being as wide as or less wide than front sheet (3).

11. A foldable sheet member as per claim 1, characterized in that the cut out contour of said at least one flap (8) has been die-cut in back sheet (4) in such a way that when flap (8) has been turned around its corresponding folding line (6) a back frame is left surrounding the opening left by said flap.

12. A foldable sheet member as per claim 11, characterized in that said back sheet (4) has a superimposed panel (16) with a cutaway central area leaving a frame (17) around it and at least one inlet passage between the back sheet (4) and said frame (17) for the introduction of said planar member (18) with a graphic image (2) printed thereon, said planar member (18) replacing the front sheet (3), said graphic image (2) being visible through said frame (17).

13. A foldable sheet member as per claim 12, characterized in that said superimposed panel (16) derives from an edge of back panel (4) and is bonded by means of adhesive to the opposite edge.

14. A foldable sheet member as per claim 1, characterized in that both said front and rear sheets (3, 4) are round-shaped, with the edges of front sheet (3) and flap (8) intended to rest on a supporting surface being curved and directly opposed to folding line (6).

15. A foldable sheet member as per claim 14, characterized in that said flap (8) is provided with an aperture (27) being of a size enough to be passed over a button (28) of a usual gannent size, thus enabling said sheet member, when in said first stable position, to be fastened to a button (28) of a garment (29).

16. A foldable sheet member as per claim 14, characterized in that said flap (8) is provided with a slit configuration (32, 33, 34) including a straight slit (32) that runs from the edge of flap (8) intended to rest on the supporting surface to near the tongue (9) or folding line (6) and a rounded slit (33) that surrounds the inner end of said straight slit (32) and has inwardly bent ends (34) at both sides of straight slit (32) near said edge of flap (8), said slit configuration (32, 33, 34) defining a second flap (36) within flap (8), said second flap (36) enabling said sheet member, when in said first stable position, to be fastened to one edge of any piece of sheet material (35).

17. A process for the manufacture of a sheet support as per claim 3, in particular with its front surface printed, such as a personalized card, characterized by the steps of:
a) die-forming on a back sheet of advantageously big extension (40) a number of slits and indentations at preestablished locations respectively corresponding to toes or tongues (9) and to folding lines (6) of a plurality of flaps (8) of corresponding adjacent back sheets (4) provided to be obtained from said back sheet of big extension (40);
b) applying an adhesive layer (50) on said back sheet of big extension (40) leaving reserved inner areas (60) with no adhesive including at least regions corresponding to said flaps (8) with their toes or tongues (9);
c) superimposing and bonding by means of said adhesive layer (50) said back sheet of big extension (40) on and to a front sheet of big extension (30) of the same dimensions thus forming an assembly consisting of front and back sheets of big extension (30, 40) bonded together at least all around their contour; and
d) cutting said assembly consisting of said front and back sheets of big extension (30, 40) bonded together, said cutting following cutting lines marked on one or the other visible surface of said front and back sheets of big extension (30, 40) in order to thus obtain subassemblies containing several of said sheet supports apt to be printed and cut into individual sheet support elements, or in order to thus obtain individual sheet support elements apt to be printed.

18. A process as per claim 17, characterized in that step a) includes a preparation of said back sheet of big extension (40) comprising printing on it at least guiding lines for said die-forming of said slits and indentations, and/or guides for said ulterior cutting into subassemblies, and/or guides for said final cutting into individual sheet support elements.

19. A process as per claim 17, characterized in that printing of graphic images (2) is carried out on at least the front sheet of big extension (30) of said subassemblies containing several sheet supports with each of said graphic images (2) being equal or different and at a location corresponding to one of said sheet supports before their being cut into individual sheet support elements.

20. A process as per claim 17, characterized in that printing of graphic images (2) is carried out on at least the front sheet (3) of each of said sheet supports after their having been cut into individual elements.

21. A process as per claim 17, characterized in that printing of graphic images (2) is carried out on at least the front sheet of big extension (30) of the assemblies consisting of said mutually bonded front and back sheets of big extension (30, 40) obtained in step c) before their being cut into individual sheet support elements.

22. A process as per claim 17, characterized in that printing of graphic images (2) is carried out on at least the front sheet of big extension (30) before bonding it to the back sheet of big extension (40) in step c).

23. A toy shooting device formed by a sheet support as per claim 1. characterized in that a ratio of the length of said flap (8) to the length of the back sheet (3), a location of said folding line (6) with relation to said front sheet (3), a distance from said adhesive stripe (21) to folding line (6), a length of said toe or tongue (9), and a rigidity and resiliency of the sheet material have been selected in such a way that when resting in an erect position on a flat surface and with flap (8) in said second position said sheet support admits certain repeated strains produced by pressing or tapping the topmost edge of front sheet (3) without folding and in such a way that said strains cause the bottom end of said front sheet (3) to be flipped forwards thus being in a position to impel a small object such as a small paper ball or a small ball placed in front of the sheet support on said flat surface.

24. A toy shooting device as per claim 23, characterized in that said length of flap (8) is of about 45% to 55%, preferably 50%, of the length of front sheet (3); said location of folding line (6) is at about 45% to 55%, preferably 50%, of the length of front sheet (3) with respect to a bottom edge of this latter; said distance from adhesive stripe (21) to folding line (6) is of about 5% to 20% of the length of flap (8); said length of toe or tongue (9) is of about 5% to 10% of the length of flap (8); and the sheet material is a cardboard or paperboard having at least one of its sides coated with plastic.

25. A toy shooting device as per claim 23, characterized in that said graphic image (2) printed on front sheet (3) reproduces the image of a player of a sport especially a sport using a ball or the like, such as in football or hockey.

26. A toy shooting device as per claim 23, characterized in that a complement has been provided which is formed by a sheet bent along a transverse folding line thus defining two planes arranged in the shape of an inverted “V” having one of its slopes cut out thus defining an opening by way of a goal such as a football or a hockey goal.
